(19) United States
(12) Patent Application Publication
(10) Pub. No.: US 2026/0187181 A1
(43) Pub. Date: Jul. 2, 2026

(54) NON-TRANSITORY COMPUTER-READABLE RECORDING MEDIUM, CALCULATION METHOD AND INFORMATION PROCESSING DEVICE

(71) Applicant: Fujitsu Limited, Kawasaki-shi (JP)

(72) Inventors: Akito MARUO, Atsugi (JP); Ayano HASOME, Kawagoe (JP); Hajime IGARASHI, Sapporo (JP)

(73) Assignee: Fujitsu Limited, Kawasaki-shi (JP)

(21) Appl. No.: 19/546,650

(22) Filed: Feb. 23, 2026

Related U.S. Application Data
(63) Continuation of application No. PCT/JP2023/032332, filed on Sep. 5, 2023.

(51) Int. Cl. G06F 17/11

(52) U.S. Cl. CPC G06F 17/11

(57) ABSTRACT

A non-transitory computer-readable recording medium that stores a program causing a computer to execute a process, the process including, when converting an analysis target into an evaluation function and searching for a solution, generating a plurality of evaluation functions by reflecting variations in at least any element of the evaluation function, generating an objective function by combining the plurality of evaluation functions, and searching for a solution in the objective function.

### CROSS-REFERENCE TO RELATED APPLICATION

This application is a continuation application of PCT/JP2023/032332, filed on Sep. 5, 2023, the entire contents of which are incorporated herein by reference.

### FIELD

A certain aspect of embodiments described herein relates to a non-transitory computer-readable recording medium, a calculation method and an information processing device.

### BACKGROUND ART

A variety of industries face optimization problems aimed at achieving favorable results. Research is being conducted into optimization algorithms that seek exact solutions to these optimization problems that achieve the highest computational results. For example, there is technology that formulates the analysis target in QUBO format and searches for the optimal solution (see, for example, Japanese Patent Application Publication No. 2022-118555, Japanese Patent Application Publication No. 2022-117957, Japanese Patent Application Publication No. 2022-067101, and Japanese Patent Application Publication No. 2022-031119).

### SUMMARY

In one aspect, there is provided a non-transitory computer-readable recording medium that stores a program causing a computer to execute a process, the process including: when converting an analysis target into an evaluation function and searching for a solution, generating a plurality of evaluation functions by reflecting variations in at least any element of the evaluation function, generating an objective function by combining the plurality of evaluation functions, and searching for a solution in the objective function.

### BRIEF DESCRIPTION OF THE DRAWINGS

FIG. 1 is a diagram illustrating optimization results for product placement in a packaging box.

FIG. 2 is a diagram explaining a QUBO format.

FIG. 3A is a functional block diagram of an overall configuration of an information processing device according to Embodiment 1, and FIG. 3B is a block diagram illustrating a hardware configuration of each part of the information processing device.

FIG. 4A is a diagram illustrating an example of an analysis target for magnet placement, and FIG. 4B is a diagram illustrating a target value.

FIG. 5 is a flowchart of an example of an operation of an information processing device.

FIG. 6 is a diagram illustrating synthesis of objective functions.

FIG. 7 is a diagram illustrating an example of an analysis target.

FIG. 8A is a result of a comparative example, FIG. 8B is a result of an embodiment, and FIG. 8C is magnetic flux density at each observation point relative to a target value B0.

FIG. 9A is a diagram of a relationship between a number of QUBOs generated and an average error, FIG. 9B is a diagram of a case where the number of QUBOs generated is 10 using a method of the embodiment, and FIG. 9C is a diagram of a case where the number of QUBOs generated is 50 using the method of the embodiment.

### DESCRIPTION OF EMBODIMENTS

In reality, there are cases where work is not performed according to the exact solution, or where physical properties are not obtained according to the exact solution. In these cases, the effects that would be obtained with the exact solution may be significantly reduced.

Prior to explaining the embodiments, an overview of optimization algorithms will be described.

Optimization problems exist in a variety of industries, including the distribution and manufacturing industries. Research is being conducted into optimization algorithms that seek exact solutions to these problems that achieve the highest computational effectiveness.

Here, the exact solution is a solution that maximizes the evaluation index. For example, in a production line, evaluation indexes include production completion time, delivery date, and production cost. In a packing operation, evaluation indexes include the amount of wasted materials and work time. An optimization algorithm uses one or more evaluation indexes as an objective function and performs optimization to improve the objective function. Note that in a production line, input variables include the initial product introduction order on the production line, as well as conditions such as the work time required for each product. In a packing operation, input variables include the initial packing order of products, as well as conditions such as the size, weight, and box size of each product. The resulting solution is the order in which products are introduced onto the production line. In the packing operation, the resulting solution is, for example, the order in which products should be packed.

Optimization algorithms can obtain the exact solution that maximizes the evaluation index. However, when attempting to actually apply the exact solution obtained by these optimization algorithms, various variations can occur, making it difficult to perform the operation according to the exact solution, or physical properties cannot be obtained according to the exact solution, resulting in a slight deviation from the exact solution.

Here, the exact solution obtained using conventional methods is often a solution that achieve high local effectiveness. Therefore, if the work content or physical properties deviate from the exact solution (for example, tolerances occur), the effectiveness may decrease dramatically, and the expected results may not be necessarily achieved.

For example, in the packing operation, differences in worker proficiency can increase the time required for the operation, or size errors in the products handled can prevent the packing operation from being performed according to the exact solution. These are all possible situations that can occur in real-world situations. If these issues occur, the work content will deviate from the exact solution.

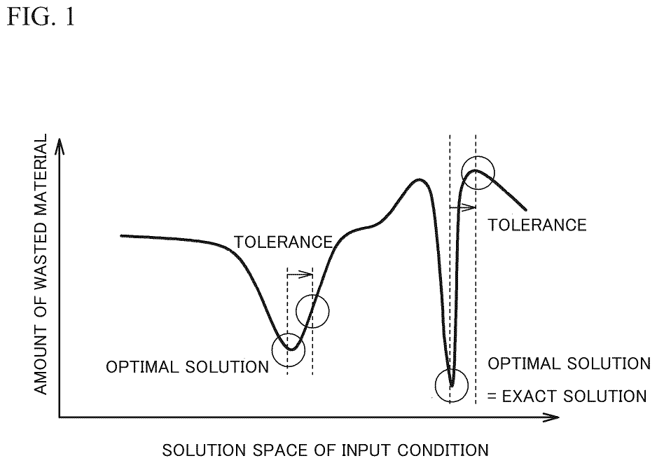

FIG. 1 is a diagram illustrating the optimization results for product placement in a packaging box. Packing products tightly into a packaging box can reduce the amount of wasted material. Therefore, it is possible to use an optimization algorithm to find the optimal solution for packing products into a packaging box. FIG. 1 is a diagram illustrating an optimal solution. In FIG. 1, the horizontal axis represents the solution space of the input conditions, and the vertical axis represents the amount of wasted material. In the example in FIG. 1, evaluation is performed using a single evaluation index: the amount of wasted material.

For example, the optimal solution on the right side of FIG. 1 is the exact solution because it minimizes the amount of wasted material. While this exact solution significantly reduces the amount of wasted material, because the solution exists locally, even a slight deviation from the exact solution can significantly increase the amount of wasted material. On the other hand, the optimal solution on the left side does not reduce the amount of wasted material as much as the exact solution, but compared to the exact solution, the solution does not exist locally (the difference in the amount of wasted material with neighboring solutions is small). Therefore, even if the work content deviates slightly from the optimal solution, the amount of wasted material does not increase significantly. In actual work sites, a highly robust optimization algorithm that can achieve results close to the optimal solution, even when the work content deviates from the optimal solution, is required.

Here, MORDO (multi-objective robust design optimization) is an example of a robust optimization method. This method repeatedly samples and varies the design variables being searched for during the optimization calculation, and then statistically processes and evaluates the resulting indices. Designs that lack robustness against variation result in large variations in the objective function obtained through repeated calculations. For example, by using the standard deviation of the objective function as an index of variation and minimizing this index, a design solution with high tolerance to variation can be obtained. However, a drawback of this method is the enormous amount of calculation required due to multiple sampling.

To overcome the problem of computation time, another highly robust optimization method is the robust genetic algorithm (GA). The robust GA method uses a genetic algorithm (GA) as the optimization engine, generating variations for each evaluation of the genetic algorithm's evolution to achieve generational evolution. Alternatively, a hybrid method combining the MORDO method and the robust GA method can be considered. However, these methods use a genetic algorithm (GA), which limits the problems to which they can be applied. In particular, GA is generally unsuitable for calculations involving a huge number of input variables from the perspective of convergence.

In the following embodiment, a description will be given of an embodiment that allows for formulation of QUBO (Quadratic Unconstrained Binary Optimization), which is treated as an optimization problem, while taking fluctuations into account.

### Embodiment 1

First, the QUBO format will be given. The QUBO format stands for Quadratic Unconstrained Binary Optimization, and is a format that allows for binary optimization without quadratic constraints. The QUBO format can be expressed, for example, as in the following equation. Note that xᵢ=0 or 1 (i=1, . . . , N). Wᵢⱼ is the coupling coefficient between xᵢ and xⱼ. bᵢ is the bias coefficient for xᵢ. The first term on the right-hand side is a quadratic term, representing the interaction. The second term on the right-hand side is a linear term, representing the bias effect. The third term on the right-hand side is a constant term.

$$E ( x ) = - {\sum }_{i , j} {W}_{ij} {x}_{i} {x}_{j} - {\sum }_{i} {b}_{i} {x}_{i} + const . \qquad [ Equation 1 ]$$

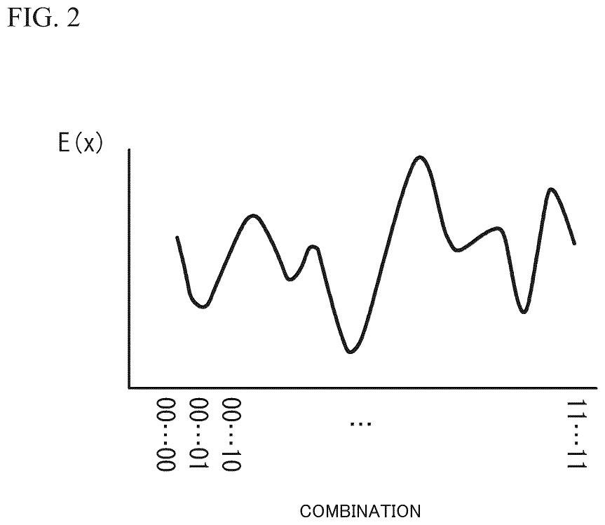

In the QUBO format, a solution is searched for according to the above equation. For example, if the optimal solution is one in which E(x) is smallest, a good solution x for minimizing E(x) is searched for, as illustrated in FIG. 2. For example, E(x) is calculated for the initial value of x, the value of x is changed and E(x) is calculated, and the value of x is further changed and E(x) is calculated, and this process is repeated. The x obtained when the smallest E(x) among the E(x) s obtained from each calculation is the solution.

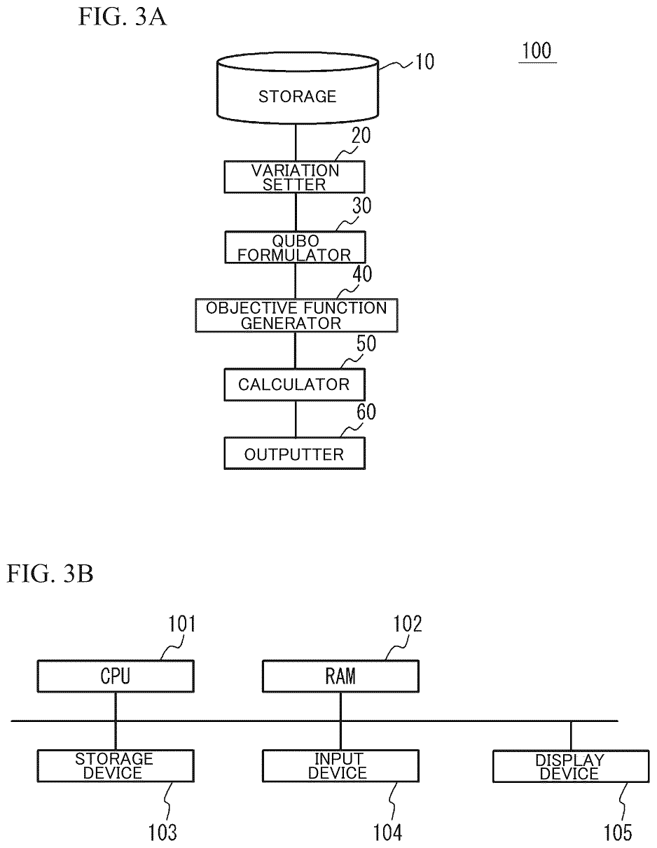

FIG. 3A is a functional block diagram of the overall configuration of an information processing device 100 according to Embodiment 1. The information processing device 100 is, for example, a server for optimization processing. As illustrated in FIG. 3A, the information processing device 100 includes a storage 10, a variation setter 20, a QUBO formulator 30, an objective function generator 40, a calculator 50, and an outputter 60.

FIG. 3B is a block diagram illustrating the hardware configuration of each part of the information processing device 100. As illustrated in FIG. 3B, the information processing device 100 includes a CPU 101, a RAM 102, a storage device 103, an input device 104, a display device 105, and so on.

The CPU (Central Processing Unit) 101 is a central processing unit. The CPU 101 includes one or more cores. The RAM (Random Access Memory) 102 is a volatile memory that temporarily stores programs executed by the CPU 101 and data processed by the CPU 101. The storage device 103 is a non-volatile storage device. For example, the storage device 103 can be a ROM (Read Only Memory), a solid-state drive (SSD) such as flash memory, or a hard disk driven by a hard disk drive. The storage device 103 stores a calculation program. The input device 104 is an input device such as a mouse or keyboard. Alternatively, the input device 104 is an interface such as an external memory such as a USB memory. The display device 105 is a device such as a display that displays the processing results of the information processing device 100. The CPU 101 executes the calculation program to realize each part of the information processing device 100. Note that each part of the information processing device 100 may also be implemented using hardware such as dedicated circuits.

In the embodiment 1, as an example, optimization of magnet placement will be described. In magnet placement, the optimal solution is sought when the desired magnetic flux density is achieved. Even if an exact solution is obtained for magnet placement, even a slight deviation from the exact solution due to variations in magnetization or the like, may result in the desired magnetic flux density not being achieved. Therefore, a highly robust optimization algorithm that can achieve an effect close to the optimal solution is required for magnet placement as well.

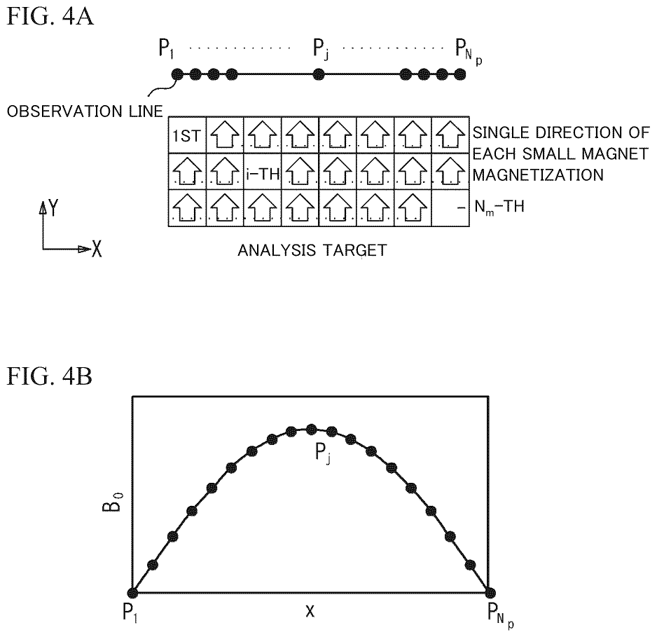

The storage 10 stores the magnet arrangement analysis target. FIG. 4A is a diagram illustrating an example of the magnet arrangement analysis target. As illustrated in FIG. 4A, magnets can be arranged at predetermined intervals in the X-axis and Y-axis directions. Each small magnet is assumed to be magnetized in one direction. FIG. 4B is a diagram illustrating target values. In the example of FIG. 4B, the magnetic flux density at each observation point is required to form a sinusoidal wave shape along the observation line.

As an example, for the magnet arrangement analysis target, the magnet arrangement is determined so that the target value illustrated in FIG. 4B is obtained. The magnetic flux density B generated by magnets at observation points P (P₁ to P_{Np}) can be expressed as B=μH+M. “μ” is the magnetic permeability of a vacuum. “H” is the magnetic field. According to this formula, the magnetic flux density B changes when there is a change in the magnitude of the magnetization M of each small magnet (Biot-Savart's law). In this magnet placement optimization problem, as an example, a magnet placement is sought that minimizes the error from the target value of the magnetic flux density at each observation point, even if fluctuations in magnetization M occur due to some factor.

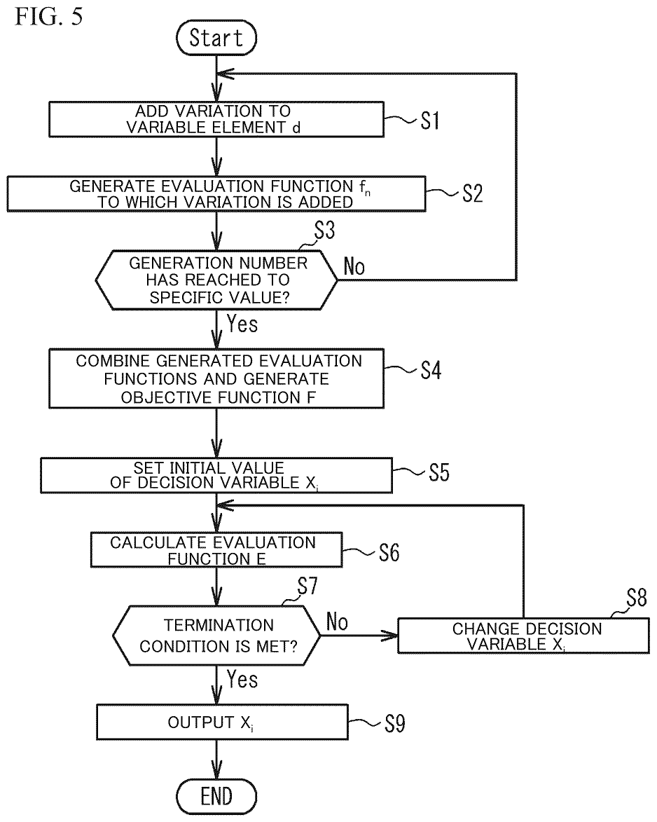

FIG. 5 is a flowchart illustrating an example of the operation of the information processing device 100. Below, an example of the operation of the information processing device 100 will be described in accordance with the flowchart in FIG. 5.

First, the variation setter 20 assigns a variation value to the variable element d (step S1). For example, the variation setter 20 sets a variation value according to a Gaussian distribution. A different variation value is set each time step S1 is executed.

Next, the QUBO formulator 30 generates an evaluation function fₙ to which the variation value has been assigned (step S2). When step S2 is executed the first time, an evaluation function f₁ is generated, when step S2 is executed the second time, an evaluation function f₂ is generated with a different variation value, and when step S2 is executed the third time, an evaluation function f₃ is generated with an even different variation value.

For example, if the above magnet placement analysis object is formulated in QUBO format, the following evaluation function f is obtained as an evaluation index. In the following equation, B_{y}^{(i, j)} represents the magnetic flux density in the Y-axis direction at the observation point Pⱼ of the i-th magnet. B₀^{(j)}(M) is the target value. sᵢ=0 means that no magnet is placed at the observation point Pᵢ of the i-th magnet. sᵢ=1 means that a magnet is placed at the observation point Pi of the i-th magnet. The smaller the difference between the searched B_{y}^{(i, j)} and the target value B₀^{(j)}(M), the better the solution. Therefore, a combination of 0 and 1 in sᵢ (i=1 to Nₚ) is searched for to minimize the following equation.

$$ℋ = {\sum }_{j = 1}^{{N}_{p}} {( {B}_{y}^{( j )} ( M ) - {B}_{0}^{( j )} ( M ) )}^{2} = {\sum }_{j = 1}^{{N}_{p}} {( {\sum }_{i = 1}^{{N}_{m}} {B}_{y}^{( i , j )} ( M ) {s}_{i} - {B}_{0}^{( j )} ( M ) )}^{2} \to min . \qquad [ Equation 2 ]$$

$${s}_{i} = \{ \begin{matrix}0 & air \\ 1 & magnet\end{matrix} \qquad [ Equation 3 ]$$

In this embodiment, the QUBO formulator 30 assigns the variation value set by the variation setter 20 to the above evaluation function f. In this embodiment, as an example, the magnetization M is used as the variable element d, and the variation value is reflected in the magnetization M. ΔM represents the variation value.

$$B = μ H + ( M + Δ M ) \qquad [ Equation 4 ]$$

$$ℋ = {\sum }_{j = 1}^{{N}_{p}} {( {B}_{y}^{( j )} ( M + Δ M ) - {B}_{0}^{( j )} ( M + Δ M ) )}^{2} = {\sum }_{j = 1}^{{N}_{p}} {( {\sum }_{i = 1}^{{N}_{m}} {B}_{y}^{( i , j )} ( M + Δ M ) {s}_{i} - {B}_{0}^{( j )} ( M + Δ M ) )}^{2} \to min . \qquad [ Equation 5 ]$$

Next, the QUBO formulator 30 determines whether the number of QUBO-format evaluation functions generated has reached a specified value (step S3). If step S3 returns “No,” the process is repeated from step S1.

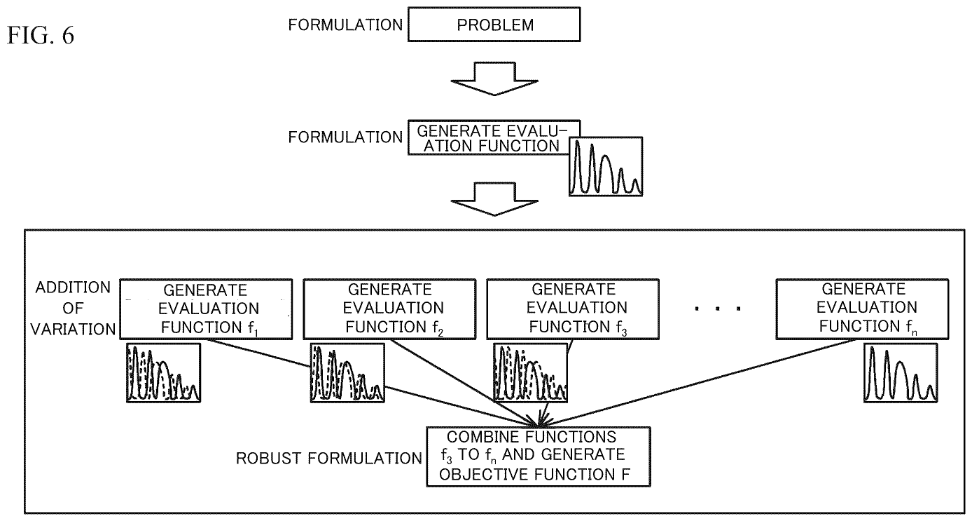

If step S3 returns “Yes,” the objective function generator 40 combines the evaluation functions generated by the QUBO formulator 30 to generate a single objective function F (step S4). For example, as illustrated in FIG. 6, the objective function F is generated by combining evaluation functions f₁, f₂, f₃, . . . , fₙ, which are evaluation functions f created by the QUBO formulator 30 through QUBO formulation and which are given variation. The synthesis in this case is not particularly limited, but may be a simple arithmetic average or a weighted arithmetic average.

Next, the calculator 50 sets an initial value for the decision variable xᵢ (step S5). In this embodiment, the decision variable xᵢ is a combinations of 0 and 1 in the evaluation function sᵢ (i=1 to Nₚ).

Next, the calculator 50 calculates the objective function F using the decision variable xᵢ as the evaluation function E(x) (step S6).

Next, the calculator 50 determines whether the termination condition is met (step S7). For example, it determines whether step S6 has been executed a specified number of times. Alternatively, it may determine whether a value below a threshold is obtained as the evaluation function E(x).

If the result of step S7 is “No,” the calculator 50 changes the initial value of the decision variable xᵢ (step S8). Then, the process is executed again from step S6.

If the result of step S7 is “Yes,” the outputter 60 outputs the decision variables xᵢ resulting in the lowest evaluation function E(x) as the optimal solution (step S9). The output decision variable xᵢ is displayed on the display device 105 or the like.

In this embodiment, variations are introduced into the elements included in the evaluation function obtained by formulating the analysis target in a QUBO format to create each evaluation function, and a solution is searched for the objective function obtained by combining these evaluation functions. With this configuration, solutions with low robustness (steep peaks) have low evaluation values, while solutions with high robustness (gentler peaks) have relatively high evaluation values. Therefore, it becomes possible to identify highly robust solutions. Note that the search method for the decision variable xᵢ is not limited to the above, and any optimization method can be applied. For example, a genetic algorithm or the like may be applied.

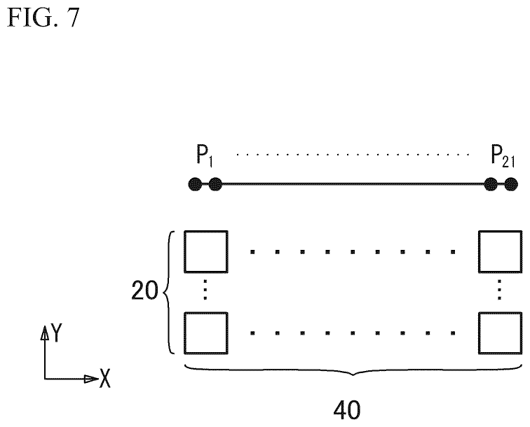

(Simulation Results) The magnet arrangement was optimized using a simulation based on the above example. As illustrated in FIG. 7, the magnet arrangement was 40×20=800 magnets. The size of each small magnet was 10 mm×10 mm×10 mm. The distance between the magnet and the observation line was 10 mm. The number of samples along the line was 21. The average value of each variation value set by the variation setter 20 was set to 0, and the standard deviation was set to 25% of the reference value. The reference value was set to magnetization M=1.2 A/m. The number of evaluation functions f₁ to fₙ generated by the QUBO formulator 30 by reflecting each variation value in the evaluation function f was 50 (=n).

For comparison, in the comparative example, optimization was performed without introducing variation into the magnetization M. In other words, the evaluation function f was used as the objective function F.

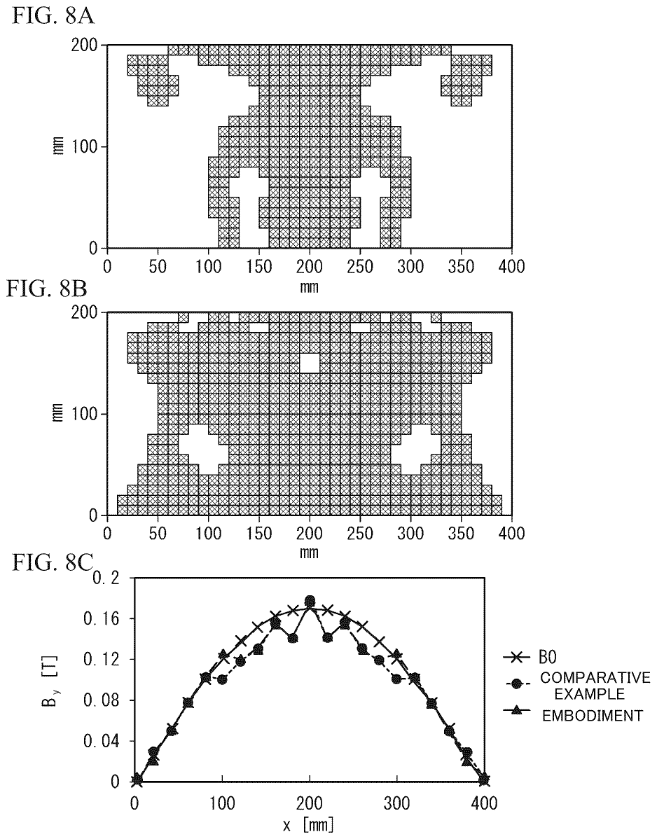

FIG. 8A illustrates the results of the comparative example. The gray areas indicate the locations of the magnets. FIG. 8B illustrates the results of the above embodiment. The gray areas indicate the locations of the magnets.

The method used in the above embodiment minimizes the impact of fluctuations, resulting in a large number of magnets being placed. In the comparative example, many magnets are placed in the upper part of the figure, which allows the magnetic flux density at the observation point to be as expected. However, if fluctuations in magnetization occur, fluctuations in the magnets in the upper part can easily change the magnetic flux density at the observation point. In contrast, the method used in the above embodiment reduces the impact of fluctuations by placing fewer magnets in the upper part, and by placing magnets overall, fluctuations in the magnetic flux density at the observation point can be suppressed.

FIG. 8C illustrates the magnetic flux density at each observation point relative to the target value B₀. In the comparative example, fluctuations are observed in the magnetic flux at the 100 mm and 300 mm points. In contrast, it can be seen that these fluctuations are suppressed by the method of the above embodiment.

Next, robustness was evaluated. To evaluate robustness, the magnetization M was varied 50 times with different values, and the average error from the target value of the magnetic flux density at each observation point was calculated using the following equation:

$$Δ {B}_{y}^{a v e} = \frac{{\sum }_{i}^{{N}_{p}} \vert {B}_{y}^{( j )} - {B}_{0}^{( j )} \vert}{{N}_{p}} \qquad [ Equation 6 ]$$

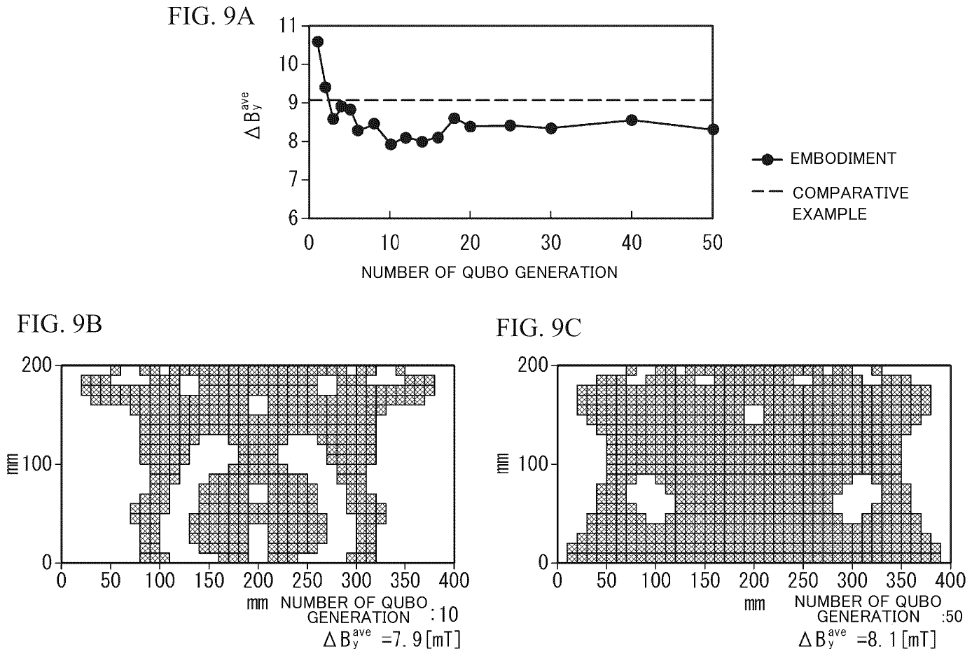

FIG. 9A illustrates the relationship between the number of QUBOs generated and the average error ΔB_{y}^{ave}. Specifically, for one magnet arrangement obtained with each number of QUBOs generated, the magnetization was varied 50 times to calculate ΔB_{y}, and the average ΔB_{y}^{ave} is plotted.

FIG. 9B illustrates the case where 10 QUBOs are generated using the method of the above embodiment. FIG. 9C illustrates the case where 50 QUBOs are generated using the method of the above embodiment. The results in FIG. 9A illustrates that this embodiment achieved a highly robust magnet arrangement with small magnetic flux density errors even when fluctuations in magnetization M occur.

Note that the results in FIG. 9A illustrates that if the number of evaluation functions generated is sufficiently large, the fluctuations will statistically become expected values, and there is a possibility that a solution that compensates for the effects of the fluctuations will not be found. This results in an increased number of magnets. Therefore, by reducing the number of evaluation functions generated and intentionally leaving the effects of fluctuations from the expected values, a highly robust solution can be obtained with a small number of magnets. From the above, it can be seen that adjusting the number of QUBO functions generated can control robust solution-finding performance.

In each of the above examples, the calculator 50 is an example of a searcher configured to, when converting an analysis target into an evaluation function and searching for a solution, generate a plurality of evaluation functions by reflecting variations in at least any element of the evaluation function, generate an objective function by combining the plurality of evaluation functions, and search for a solution in the objective function. The display device 105 is an example of a display device that displays the searched solution.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the above-described coolant may be cold water or an antifreeze solution.

What is claimed is:

1. A non-transitory computer-readable recording medium that stores a program causing a computer to execute a process, the process including:
when converting an analysis target into an evaluation function and searching for a solution, generating a plurality of evaluation functions by reflecting variations in at least any element of the evaluation function, generating an objective function by combining the plurality of evaluation functions, and searching for a solution in the objective function.

2. The medium as claimed in claim 1, wherein the variation follows a Gaussian distribution.

3. The medium as claimed in claim 1, wherein the objective function is generated by calculating an arithmetic mean of the plurality of evaluation functions.

4. The medium as claimed in claim 1, wherein the analysis target includes an array, and the solution to the objective function has order information in the array.

5. The medium as claimed in claim 1, wherein the evaluation function is expressed in QUBO format.

6. The medium as claimed in claim 1,
wherein the process includes displaying the solution on a display device.

7. A calculation method comprising:
when converting an analysis target into an evaluation function and searching for a solution, generating a plurality of evaluation functions by reflecting variations in at least any element of the evaluation function, generating an objective function by combining the plurality of evaluation functions, and searching for a solution in the objective function.

8. The calculation method as claimed in claim 7, wherein the variation follows a Gaussian distribution.

9. The calculation method as claimed in claim 7, wherein the objective function is generated by calculating an arithmetic mean of the plurality of evaluation functions.

10. The calculation method as claimed in claim 7, wherein the analysis target includes an array, and the solution to the objective function has order information in the array.

11. The calculation method as claimed in claim 7, wherein the evaluation function is expressed in QUBO format.

12. The calculation method as claimed in claim 7,
wherein the computer executes a process of displaying the solution on a display device.

13. An information processing device comprising:
a memory; and
a processor coupled to the memory and configured to:
when converting an analysis target into an evaluation function and searching for a solution, generate a plurality of evaluation functions by reflecting variations in at least any element of the evaluation function, generate an objective function by combining the plurality of evaluation functions, and search for a solution in the objective function.

14. The information processing device as claimed in claim 13,
wherein the variation follows a Gaussian distribution.

15. The information processing device as claimed in claim 13,
wherein the objective function is generated by calculating an arithmetic mean of the plurality of evaluation functions.

16. The information processing device claimed in claim 13, wherein the analysis target includes an array, and the solution to the objective function has order information in the array.

17. The information processing device as claimed in claim 13, wherein the evaluation function is expressed in QUBO format.

18. The information processing device as claimed in claim 13, comprising:
a display device configured to display the solution.
